(19) United States
(12) Patent Application Publication
(10) Pub. No.: US 2014/0228089 A1
(43) Pub. Date: Aug. 14, 2014

(54) System And Method For Conducting A Wagering Game And Associated Bonus Element

(71) Applicant: FLEETWOOD GAMING, INC., Billings, MT (US)

(72) Inventors: Kit Seaton, Billings, MT (US); Jeff Sandridge, Billings, MT (US); Daniel Dale, Brighton, CO (US)

(73) Assignee: FLEETWOOD GAMING, INC., Billings, MT (US)

(21) Appl. No.: 13/767,062

(22) Filed: Feb. 14, 2013

(51) Int. Cl. G07F 17/32

(52) U.S. Cl. CPC G07F 17/3267
USPC 463/18

(57) ABSTRACT

Systems and methods conduct a wagering game having a game set of numbers and a bonus track. A player selects a selection set of numbers from the game set. An outcome set of numbers from the game set is randomly generated. The player is rewarded, based upon a pay table, for matches between numbers in the selection set and the outcome set. If a bonus trigger condition is fulfilled, a bonus element uses a spinner to randomly determine movement of a game piece around the bonus track to identify a bonus feature that is implemented to further engage the player.

### BACKGROUND

Numbers games are well known in the art. Essentially a numbers game consists of a player selecting one or more numbers from a closed set and placing a wager. The house randomly selects a set of numbers and, if the player's selection matches the house's selection, the player is rewarded.

The most well-known numbers game is “racehorse keno,” referred to in casinos as merely “keno.” Keno uses an eighty number game set, typically the numbers one through eighty. A keno ticket includes a matrix with the eighty numbers of the game set and the player designates a selection set by marking the numbers of the player's selection set on the keno ticket. Keno tickets may be in paper and/or electronic form. Paper tickets may be punched, daubed, or otherwise marked to identify the player's selection set. Alternatively, a keno machine may include a display on which a keno ticket is displayed. The player may use a touch-screen, pointer, mouse, button panel, keyboard or keypad, or other input device to input the player's selection set. The size of the selection set may be decided by the player, although the potential payouts may relate to the size of the selection set and the number of “catches,” i.e. matches between the player's selection set and a randomly selected outcome set.

An outcome set is selected from the game set and compared to the player's selection set. In a typical keno game, the outcome set includes twenty numbers randomly selected from the eighty numbers on a keno board. A number within the player's selection set is “caught” if the number matches a number within the outcome set. For example, if the player's selection set includes the five numbers 3, 5, 10, 22, and 73, and the outcome set includes the twenty numbers 1, 5, 8, 13, 15, 19, 22 26, 27, 33, 35, 40, 49, 53, 54, 58, 65, 70, 73, and 78, the player has caught the numbers 5, 22, and 73 since those numbers appear in both the player's selection set and the randomly selected outcome set. The selection set and the caught numbers determine which, if any, of the player's wagers are rewarded.

In conventional keno, players may wager any amount on a keno ticket. Wagers in keno can be generally divided into two groups, spot and way. Spot wagers consist merely of the player selecting individual numbers, or spots, on a keno ticket. If a player catches a predetermined number of spots, the player is rewarded. For example, on a ten-spot keno ticket, the player selects and marks ten numbers. A reward is typically issued if the player catches five or more spots. Typically, the reward increases with the number of spots the player catches. For example, if the player catches five spots, the player may receive his wager back; if the player catches ten spots, the player may be paid at ten thousand to one.

Way wagers consist of a player selecting groups of numbers, or ways, on a keno ticket. If a player catches a predetermined number of spots, the player is rewarded. For example, on a hi-low way keno ticket, the player selects and marks three groups of four numbers. If a player catches five or more spots, the player is rewarded. However, the size of the reward depends on the distribution of the spots. For example, if the spots are distributed with two in one way, two in another way, and one in yet another way (2-2-1), the player's wager is returned. Alternatively, if the spots are distributed 3-1-1, the player may be paid at 1.2:1; if the spots are distributed 4-1, the player may be rewarded at 1.4:1.

One known improvement to electronic keno is the designation of bonus numbers. For example, certain numbers on the keno board (whether or not selected by a player) may be designated as bonus numbers. If a bonus number is caught, a bonus payout or other bonus feature is conducted.

### SUMMARY OF THE INVENTION

In one embodiment, a method for conducting a wagering game, within a wagering game system and with a player, having a game set of numbers. The method receives, using an input device of the wagering game system, a selection set comprising a regular selection set of different numbers selected from the game set and a bonus selection set of different numbers selected from the game set and different from the regular selection set. The method generates an outcome set comprising a predefined quantity of randomly selected different numbers from the game set. The method generates a hit set of numbers in common to both the regular selection set and the outcome set. The method generates a bonus hit set of numbers in common between the bonus selection set and the outcome set. The method determines whether a bonus trigger condition is met based upon the bonus hit set. If the bonus trigger condition is met, the method moves a game piece from a current location to a destination location on a bonus track, wherein the destination location defines a bonus feature. The method implements, if the bonus trigger condition is met, the bonus feature within the wagering game.

In certain embodiments, the method further determines a pay award based upon a pay table and at least one of: (i) a count of numbers in the hit set, (ii) a count of numbers in the bonus hit set, and the identified bonus feature if the bonus trigger condition is met. In certain embodiments, the pay table may define the pay award based upon one or more of (i) an amount of wager received by the player, (ii) the quantity of numbers in the regular selection set, and/or (iii) the quantity of numbers in the bonus selection set.

In certain embodiments, the bonus trigger condition is met where the bonus hit set contains one number. In alternative embodiments, the bonus trigger condition is met where the bonus hit set contains more than one number.

In certain embodiments, the method moves the game piece by randomly selecting at least two destination segments of a bonus track and advancing in a defined direction around the bonus track, the game piece from the current location track segment to the first encountered of the at least two destination segments. In certain embodiments, the method may randomly select at least two destination segments by displaying an animation of a spinner on the display of the wagering game system, wherein the animation stops to indicate one of a plurality of spinner segments. Each spinner segment may have a visual representation that is associated with at least two track segments of the bonus track that have the same visual representation of the spinner segment. In certain embodiments, the visual representation is chosen from the group consisting of: color, fill patterns, shading, alpha-numerical identifiers, and logo identifiers.

In certain embodiments, the method awards bonus features selected from the group comprising: free games, spin again, free picks, bonus payouts, and payout multipliers.

In one embodiment, a system for displaying a computer-implemented wagering game with a game set comprised of a set of numbers. The system comprises a processor, a display for displaying the game set and a bonus track formed around the game set, and a memory for storing game data and software comprising machine readable instructions that when executed by the processor conduct the wagering game. The system further comprises an input device for interacting with the player to receive a selection set comprising a regular selection set of a first at least one different number selected from the game set and a bonus selection set comprising a second at least one different number from the game set, and different from the first at least one different number. The system further generates an outcome set comprising a predefined quantity of randomly selected different numbers from the game set. The system further generates a hit set of numbers that are common to both the regular selection set and the outcome set. The system further generates a bonus hit set of numbers that are common to both the bonus selection set and the outcome set. The system further determines whether a bonus trigger condition is met based upon the bonus hit set and moves a game piece, if the bonus trigger condition is met, from a current location to a destination location on a bonus track. The system further implements a bonus feature defined by the destination location if the bonus trigger condition is met.

### BRIEF DESCRIPTION OF THE FIGURES

FIG. 1 is one exemplary block diagram illustrating one exemplary system for conducting a wagering game with an associated bonus element, in an embodiment.

FIG. 2 shows the game data of FIG. 1 in further detail.

FIG. 3 shows the display device of FIG.1 displaying a graphical representation of a keno card.

FIG. 4 shows the display device FIG.1 displaying the keno card of FIG. 3 and further showing an additional outcome set.

FIG. 5 is a flowchart illustrating one exemplary method for conducting a wagering game on the system of FIG. 1.

FIG. 6 shows one exemplary selection set with eight regular selection set spots and two bonus selection set spots selected from the game set.

FIG. 7 shows one exemplary outcome set that is randomly selected by the processor of the system of FIG. 1, based upon game set.

FIG. 8 shows one exemplary overlay of the outcome set of FIG. 7 and the selection set of FIG. 6 illustrating spots common to both sets, in one embodiment.

FIG. 9 shows one exemplary sub process for conducting the bonus element of FIG. 1, in further detail, in an embodiment.

FIG. 10 is a flowchart illustrating one exemplary sub-method for conducting bonus element.

FIG. 11 depicts one exemplary method for conducting a wagering game using a powerball type bonus trigger, in one embodiment.

### DETAILED DESCRIPTION OF THE DRAWINGS

Reference is now made to the figures wherein like parts are referred to by like numerals throughout. Referring generally to the figures, the present invention includes a device and method for conducting a wagering game. A device according to an embodiment of the present invention may take any form. For example, a device may take the form of a personal computer, electronic gaming machine, kiosk, handheld device, cellular telephone, or the like.

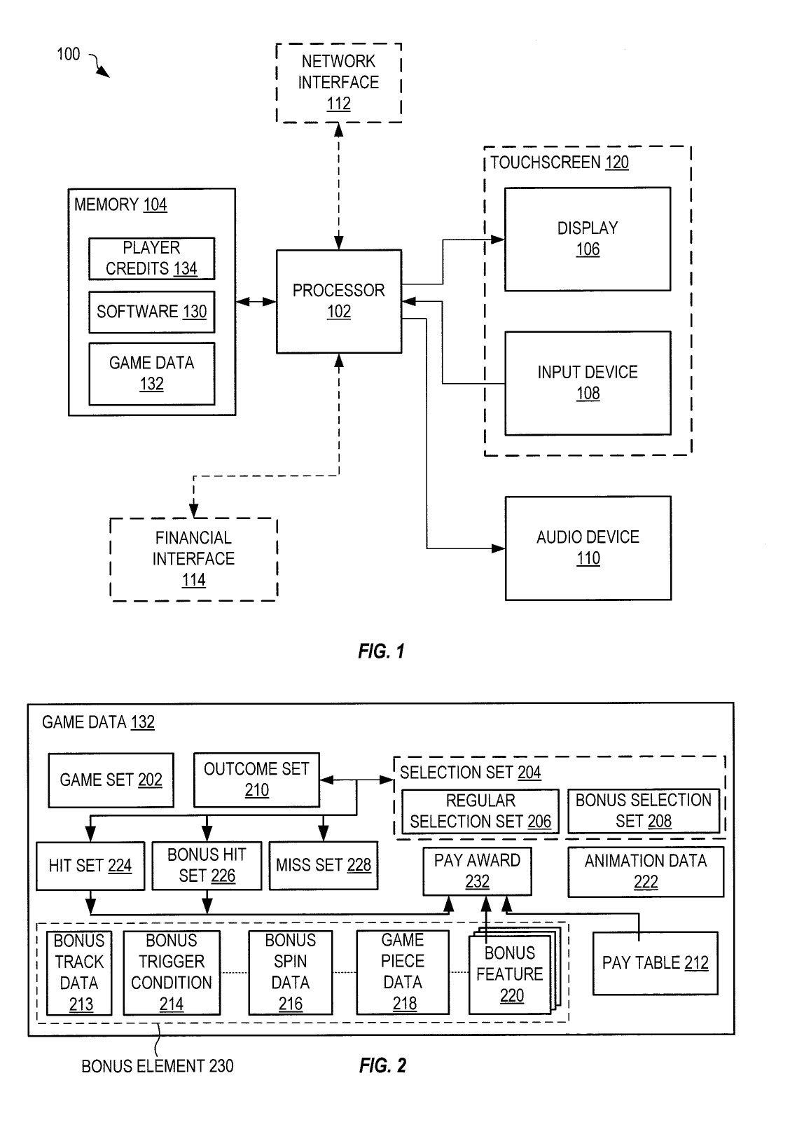

FIG. 1 is one exemplary block diagram illustrating one exemplary system 100 for conducting a wagering game with an associated bonus element 230, in an embodiment. System 100 includes a processor 102, a memory 104, a display device 106, an input device 108, and an audio device 110. Audio device 110 is for example an amplifier and at least one speaker or other sound actuator.

Display 106 may represent one or more of a liquid-crystal display (LCD), a cathode ray tube (CRT), plasma display, light emitting diode (LED), or other display medium that may be controlled electronically. It is noted that display 106 may communicate with processor 102 directly or via an intermediate controller, such as a video card or the like. Input device 108 may represent one or more of input buttons, keyboard, keypad, joystick, mouse, pointer, graphical pad, and other devices that allow a player to input information into system 100. In one embodiment, display 106 and input device 108 form a touch screen interface 120. Input device 108 may function to receive financial information from the player and display 106 may display rewards to the player. For example, the player may “log in” to system 100 and access stored credits.

Memory 104 may represent one or more of random access memory (RAM, NVRAM, etc.), read only memory (ROM), electrically erasable programmable read-only memory (EEPROM), FLASH memory, magnetic storage (e.g., a hard disk drive), and optical storage (e.g., CDROM and/or DVD drive). Memory 104 is illustratively shown storing software 130 that comprises machine readable instructions, that when executed by processor 102, allow system 100 to conduct a wagering game with the player. Memory 104 may also store graphical images, animations, and other visual files for display on display 106 and may store audio data and files for producing sound using audio device 110. Memory 104 additionally may store a player credit register 134 of the amount of credits available to the player to play the wagering game. In one embodiment, memory 104 stores animation data that includes audio information and is played on both display 106 and audio device 110.

Optionally, system 100 may include a network interface 112 for interfacing with one or more servers, and/or other gaming devices. Network interface 112 may represent one or both of a wired network interface (e.g., Ethernet) and a wireless network interface (e.g., WiFi). System 100 may also include a financial interface 114 for receiving and distributing finances. Financial interface 114 may represent one or more of a card reader/writer, a coin receiver, a bill receiver, and a payout device. For example, the player may insert coins and bank notes to buy credits for playing system 100, and may receive one or more of coins, tokens, and receipts for winnings earned from system 100. Memory 104 also stores game data 132 that represents data, stored as one or more files and/or tables, for conducting the wagering game of system 100.

FIG. 2 shows the game data 132 of FIG. 1 in further detail. FIGS. 1 and 2 are best viewed together with the following description. In a conventional game of keno, a game set consists of eighty numbers (usually the numbers one through eighty, inclusive), also referred to as ‘spots’ herein. Game data 132, within memory 104, may include a game set 202 that has an array of eighty sequentially numbered spots. The player selects a defined number (e.g., eight) of different numbers to form a regular selection set 206. The player selects a defined number (e.g., two) of different numbers to form a bonus selection set 208, where the numbers selected for bonus selection set 208 are different from the numbers selected for regular selection set 206. Numbers selected for the regular selection set 206 and the bonus selection set 208, combined, form the player's selection set 204, as indicated by the dashed outline within FIG. 2, with which the player plays the wagering game.

Processor 102 generates an outcome set 210 that includes a predefined quantity (e.g., twenty) of randomly selected different numbers from game set 202, and may store outcome set 210 within game data 132. In one embodiment, software 130 includes a pseudo random number generator that is executed by processor 102 to randomly generate outcome set 210. Outcome set 210 may include some of the same numbers included in regular selection set 206 and/or bonus selection set 208. Other sizes and ranges of numbers for game set 202 and outcome set 210 may be used without departing from the scope hereof. For example, in a game based upon Bingo, game set 202 may include the numbers one through seventy-five. Processor 102 stores outcome set 210 in game data 132.

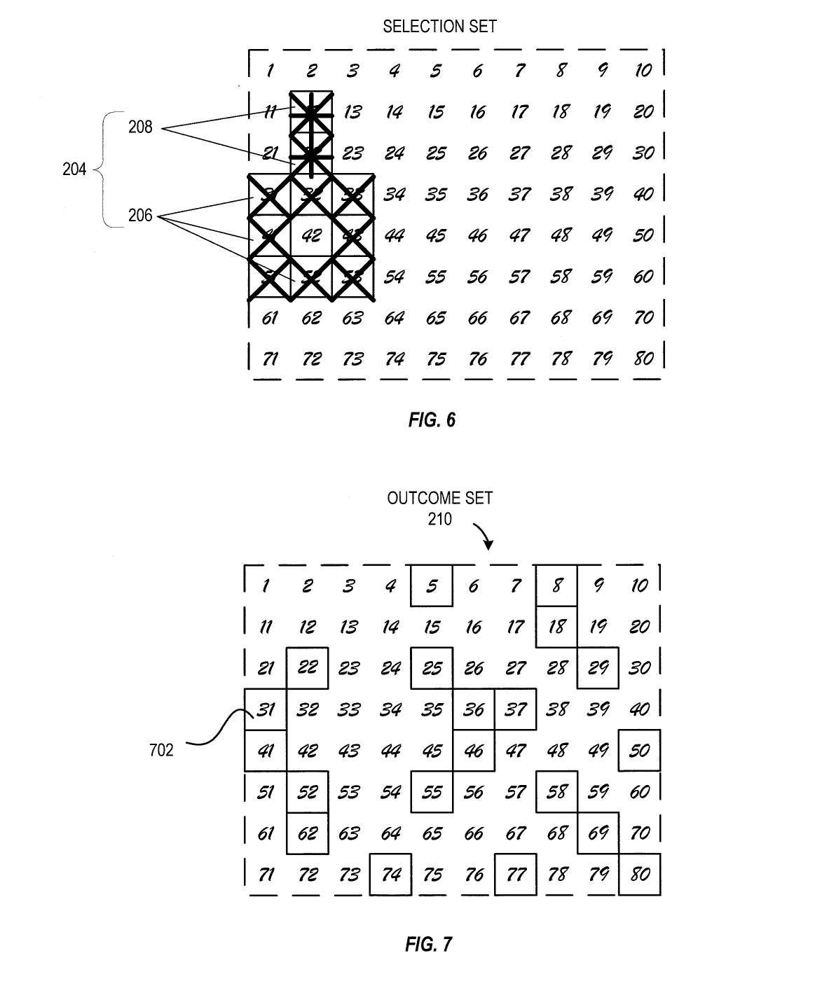

Processor 102 generates hit set 224 by determining numbers that are common to both the regular selection set 206 and the outcome set 210. Processor 102 generates bonus hit set 226 by determining numbers that are common to both the bonus selection set 208 and the outcome set 210. Optionally, processor 102 generates miss set 228 by determining numbers of the outcome set 210 that are not included within either the regular selection set 206 or the bonus selection set 208. Hit set 224, bonus hit set 226 and optional miss set 228 are stored within game data 132. In one example of operation, where, as shown in FIG. 6, regular selection set 206 contains exemplary numbers 31, 32, 33, 41, 43, 51, 52, and 53, and bonus selection set 208 contains exemplary numbers 12 and 22, and where, as shown in FIG. 7, outcome set 210 contains exemplary numbers: 5, 8, 18, 22, 25, 29, 31, 36, 37, 41, 46, 50, 52, 55, 58, 62, 69, 74, 77, and 80, processor 102 generates hit set 224 to contain the numbers 31, 41, and 52, bonus hit set 226 to contain the number 22, and, optionally, miss set 228 to contain the numbers 5, 8, 18, 25, 29, 36, 37, 46, 50, 55, 58, 62, 69, 74, 77, and 80.

Pay table 212 is a predetermined list that defines the payout awards of the wagering game. Pay table 212, for example, defines the payout award for each wager amount selectable by the player, and for each selectable quantity of numbers in the regular selection set. Additionally, pay table 212 may define payout awards for each selectable quantity of numbers in the bonus selection set. Pay table 212 additionally may define payout awards for the quantity of numbers in the hit set 224 and/or bonus set 226.

Game data 132 includes a bonus track data 213, at least one bonus trigger condition 214, bonus spin data 216, bonus game piece data 218 and at least one bonus feature 220 associated with bonus trigger condition 214. Additionally, game data 132 may include animation data 222 that is used to control display 106 during play of the wagering game.

During game play, processor 102 controls display 106 to display one or more of game set 202, selection set 204, outcome set 210, and additionally one or more of bonus feature 220, game piece location as determined by game piece data 218, and bonus spin data 216.

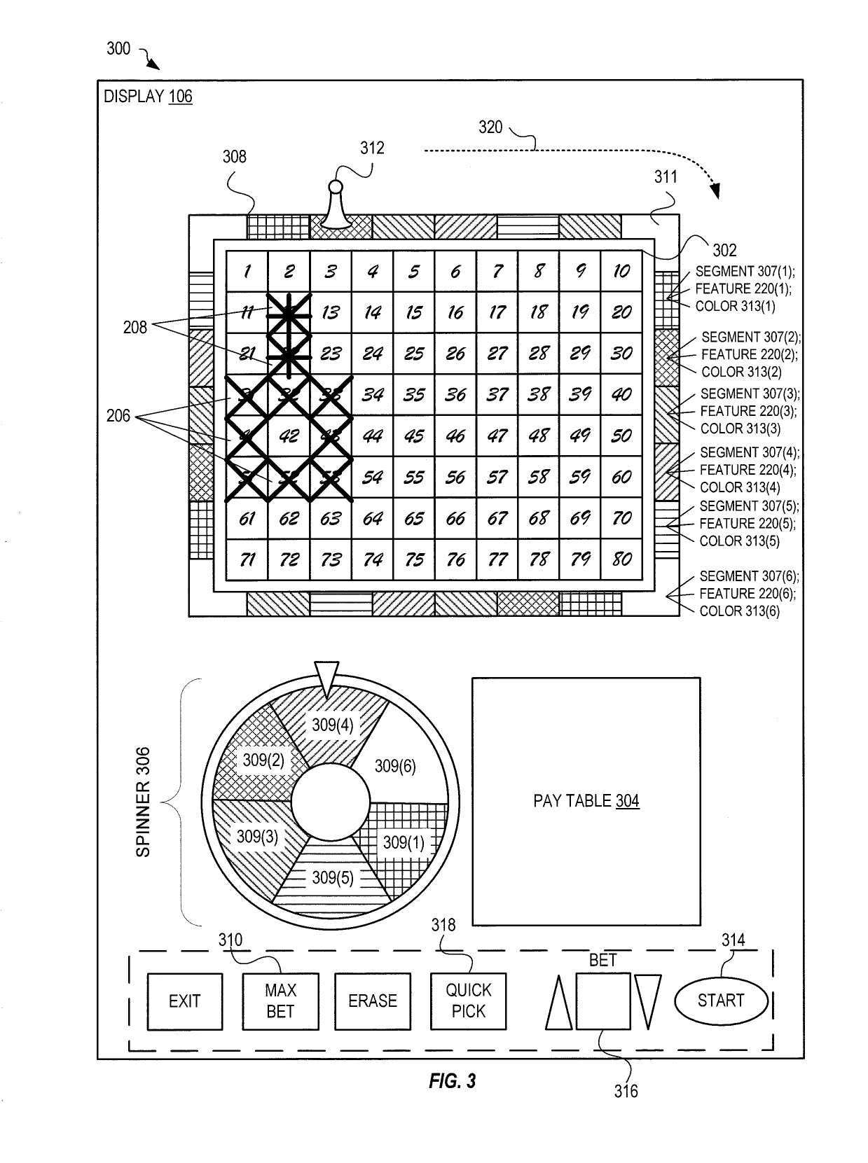

FIG. 3 shows one exemplary screen shot 300 of display 106 illustrating a keno card 302 formed as an array of ten columns and eight rows of consecutively numbered spots, a pay table 304 that displays payout values for particular number matches, a spinner 306, a bonus track 308, bonus game piece 312, and a plurality of control “buttons” 310, 314, 316, 318. Keno card 302 is a graphical representation of game set 202.

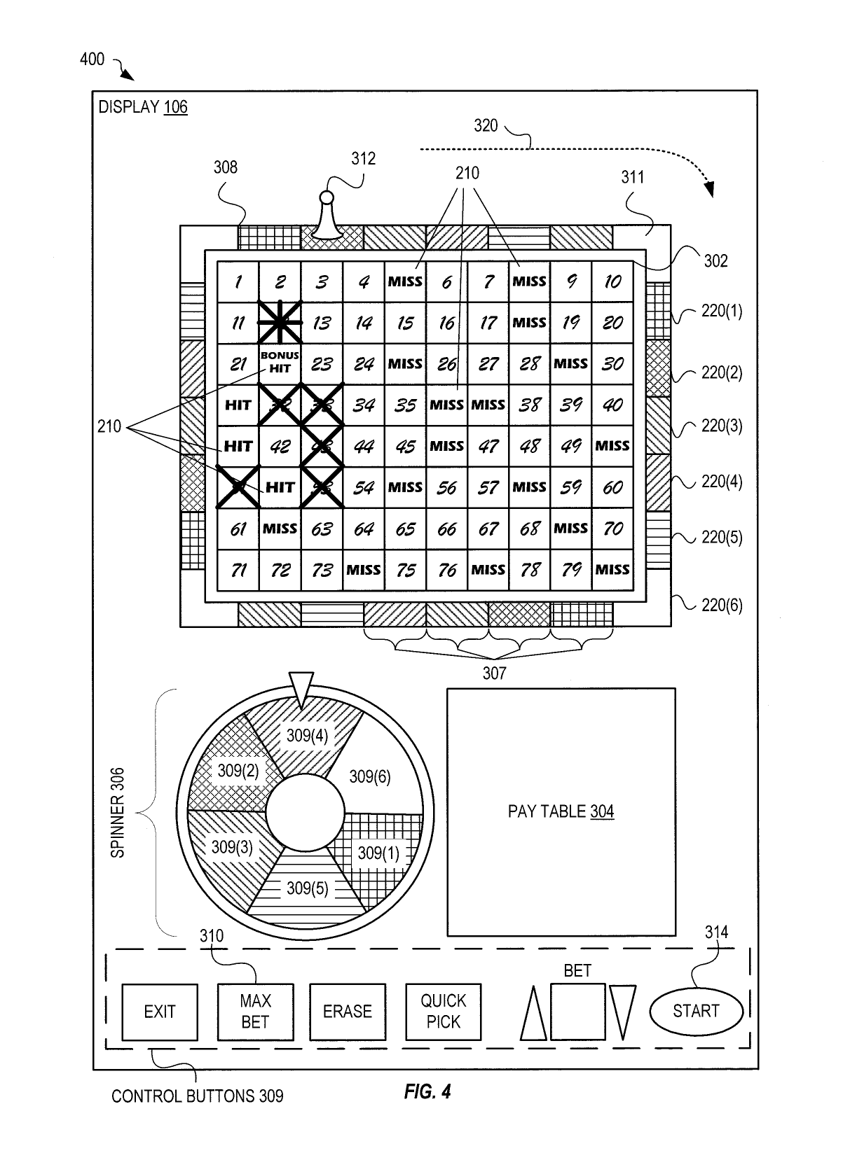

Bonus track 308 is divided into a plurality of track segments 307 and surrounds keno card 302. Each track segment 307 may correspond to one or more bonus features 220. Spinner 306 is divided into spinner segments 309(1)-309(6), where each spinner segment 309 corresponds to one or more track segments 307 of bonus track 308. For example, each spinner segment 309 may have a visual representation that corresponds to one or more track segment 307. In one embodiment, each spinner segment 309 and each corresponding track segments 307 are displayed in one of a plurality of colors 313. In FIG. 3, each different color 313 is represented by a different fill pattern. As shown in the example of FIG. 3, segments 309(1) and 307(1) are both colored yellow; segments 309(2) and 307(2) are both colored purple; segments 309(3) and 307(3) are both colored red; segments 309(4) and 307(4) are both colored blue; segments 309(5) and 307(5) are both colored orange; and segments 309(6) and 307(6) are both colored green. Those skilled in the art will recognize that the visual representation may also exhibit other identifying means, such as fill patterns, shading, alpha-numerical identifiers, logo identifiers, etcetera, that may be used to correspond a spinner segment 309 to one or more bonus track segments 307.

Where display 106 is overlaid by input device 108 to form touch-screen 120, the player interacts with touch-screen 120 to select regular selection set 206 and bonus selection set 208 from game set 202 before numbers within outcome set 210 are indicated by system 100. In one embodiment, the quantity of numbers in each of the regular selection set 206 and bonus selection set 208 is determined by the player when selecting the wager amount (e.g. a wager of one dollar allows for eight regular selection set 206 numbers and one bonus selection set 208 number). In another embodiment, the player enters a desired quantity of numbers selected for selection set 204 and processor 102 automatically configures pay table 212 based upon the quantity of numbers selected. As shown in FIGS. 3 and 4, pay table 304 is displayed upon display 106 to show how potential payout changes as selections are made for each selection set.

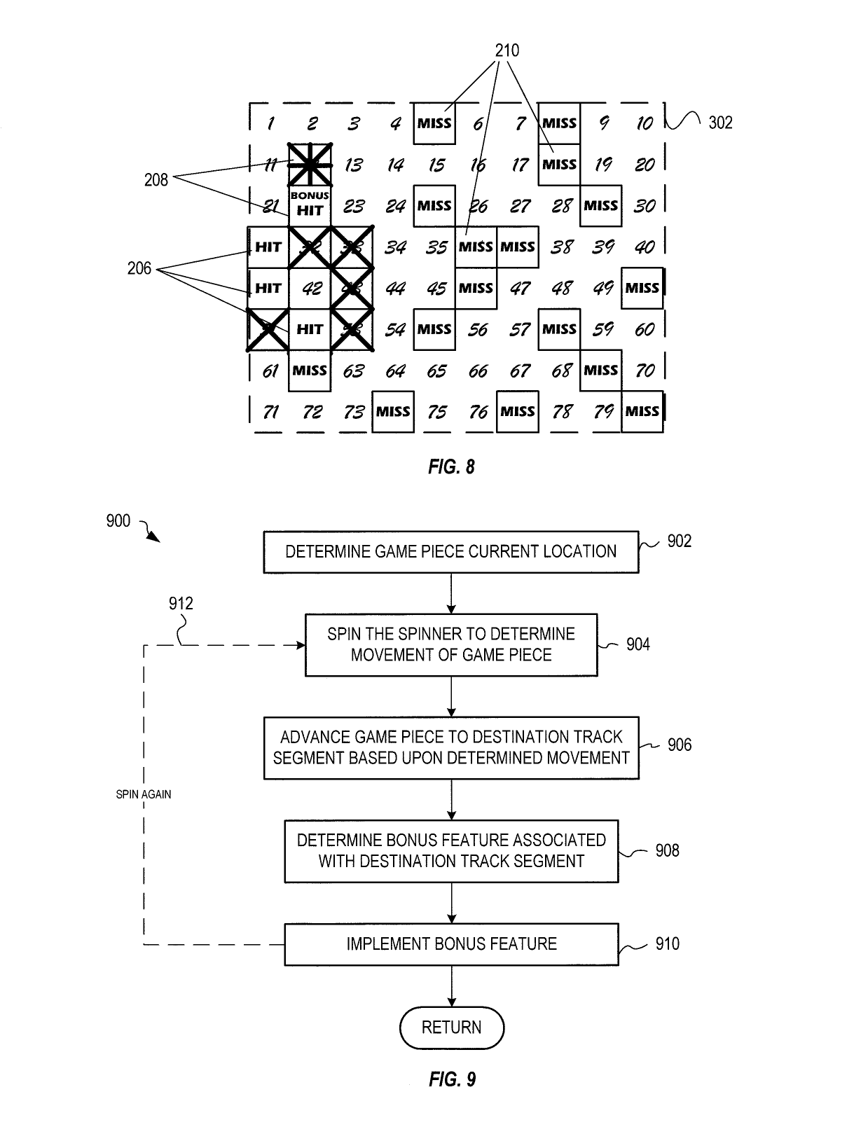

FIG. 4 shows a screen shot 400, similar to screen shot 300 but further illustrating indication of exemplary numbers of outcome set 210. In one example of operation, when the player presses a “Start” button 314, processor 102 randomly selects twenty different numbers from game set 202 to form outcome set 210, as shown in FIG. 7. Each number of outcome set 210 is indicated on display 106 for example as one of: “HIT”, “BONUS HIT”, and “MISS”. As shown in FIG. 8, “HIT” indicates where a number within outcome set 210 is also contained within hit set 224; “BONUS HIT” indicates where a number within outcome set 210 is also contained within in bonus hit set 226; and “MISS” indicates where a number in the outcome set 210 is also contained within miss set 228 (i.e., is not contained within either hit set 224 or bonus hit set 226). In certain embodiments, hit set 224, bonus hit set 226, and/or miss set 228 are identified to the player on keno card 302 displayed by display 106 using one or more of outlining, tagging, inverting, flashing, or other similar methods. In another embodiment, numbers within hit set 224 are shown with an animation of a coin over the spots where the numbers 31 and 41 would appear on keno card 302 of display 106. In another embodiment, numbers in bonus hit set 226 are shown with an animation of a treasure chest over the spot where the number 22 would appear on keno card 302 of display 106.

Processor 102 determines pay award 232, given to the player, based upon a quantity of numbers in hit set 224 and pay table data 212. Additionally, processor 102 determines whether bonus trigger condition 214 has been met based upon a quantity of numbers in bonus hit set 226. In one embodiment, bonus trigger condition 214 requires at least one number in bonus hit set 226. In another embodiment, bonus trigger condition 214 requires two or more numbers in bonus hit set 226.

Continuing with the example, bonus hit set 226 contains one number and thus processor 102 determines that bonus trigger condition 214 is met and “spins” spinner 306 to randomly select a movement of game piece 312. In one embodiment, software 130 includes a pseudo random number generator that is executed by processor 102 to randomly select one spinner segment 309 upon which spinner 306 stops. For example, software 130 uses animation data 222 to display “spinning” of spinner 306 on display 106, which shows spinner 306 slowing down to stop on the selected spinner segment. Other spinning animations may be used without departing from the scope hereof

Game piece data 218 is initialized to a predetermined track segment 307, for example track segment 307(6), where after game piece data 218 indicates a current track segment 307 of game piece 312, which advances along bonus track 308. In one embodiment, game piece 312 advances, in a direction 320, from a current position to next track segment 307 corresponding to the selected spinner segment 309. For example, where the stopped spinner segment indicates a particular color, game piece 312 may advance, in a direction indicated by arrow 320, from its current position on bonus track 308 to the next bonus track segment 307 having that particular color.

Each track segment 307 corresponds to a particular bonus feature 220 that includes one or more of: free games, free picks, spin again, bonus payouts, payout multipliers, and the like. A free pick is, for example, a randomly selected addition to the outcome set 210, after which outcome set 210 may include twenty-five numbers (i.e., twenty numbers of the original outcome set 210 plus five “free picks” awarded through the bonus feature 220). Where bonus feature 220 indicates “spin again” results, spinner 306 “spins” again and game piece 312 advances further along bonus track 308 in direction 320. A bonus payout is, for example, an additional amount of credits added to pay award 232 that is awarded to the player. A payout multiplier is, for example, a number (i.e. 1.5) by which pay award 232 is multiplied and awarded to the player. In one embodiment, bonus features 220 available on bonus track 308 are also based upon an amount of side or bonus wager entered by the player.

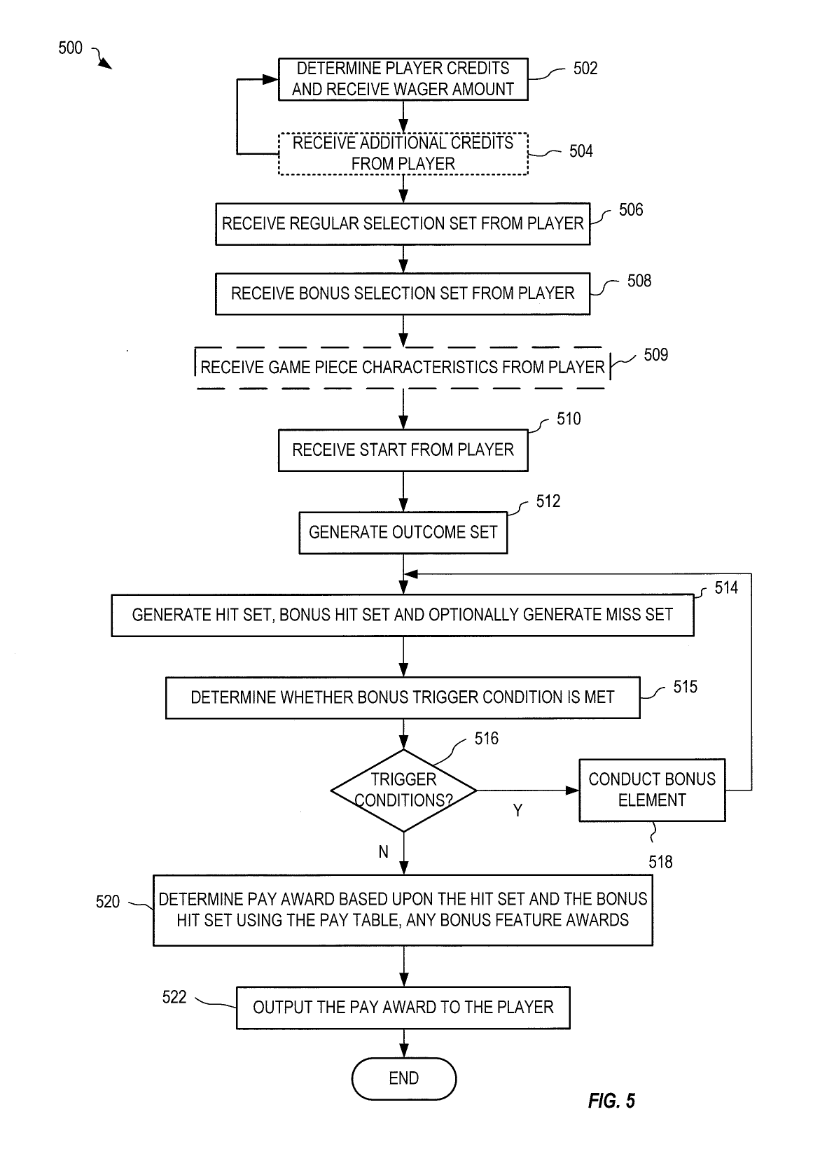

FIG. 5 is a flowchart illustrating one exemplary method 500 for conducting a wagering game on system 100 of FIG. 1. Method 500 is for example implemented as machine readable instructions that are stored as software 130 within memory 104 of system 100 and executed by processor 102 to perform the wagering game.

In step 502, method 500 determines the number of credits available to the player in player credits register 134 and receives a wager amount from the player. In one example of step 502, system 100 receives, via input device 108, an indication from the player as to a number of credits to wager on the current game. In another example of step 502, the player presses the “Max Bet” button 310, wherein system 100 receives the player's input to play a predetermined maximum wager amount available.

In one embodiment, no additional wager amount is required before the player may select a bonus selection set 208. In an alternate embodiment, a supplemental, side, or bonus wager amount is required from the player to select the one or more bonus selection set 208 numbers.

Step 504 is optional. If included, in step 504, where an insufficient amount of credits, determined in step 504, is available, method 500 receives, using financial interface 114 payment from the player (e.g. a bill, coin, ticket, credit card, electronic gaming card or the like) and processor 102 updates player credits register 134 in memory 104 and displays a total number of credits available to the player as determined from the player credit register 134. Then, step 502 may be repeated.

In step 506, method 500 receives a regular selection set from the player. In step 508, method 500 receives a bonus selection set from the player. In one example of steps 506 and 508, display 106 and input device 108 cooperate to form touch-screen 120 with which the player interacts to select desired spots from keno card 302 by touching their location on display 106. For example, system 100 may receive a regular selection set 206 and bonus selection set 208 consistent with the numbers shown in FIG. 6. In another example of steps 506 and 508, the player uses input device 108 and/or financial interface 114 to elect to use a previously stored (e.g., within memory 104 and/or on an inserted card) selection set 204.

In another example of steps 506 and 508, the player selects “Quick Pick”, via input device 108, to randomly select numbers for selection set 204 (e.g., a set of numbers randomly generated by processor 102). In yet another example of steps 506 and 508, the player indicates, via input device 108, that the selection set 204 of the previous game should be retrieved from memory 104 and used again. As numbers of selection set 204 are selected, they may be indicated on keno card 302 displayed by display 106. In one example, each number of selection set 204 is displayed on display 106 by one or more of: reversing, changing colors, outlining, tagging, or other similar indication methods. Other methods of indicating selection set 204 on keno card 302 may be used without departing from the scope hereof.

Step 509 is optional. If included, in step 509, method 500 receives, via input device 108, the player's selection of characteristics of the bonus game piece 312 for use in the current game. For example, the player selects from a predefined set of game pieces having a variety of colors, shapes, sizes, styles, figures, characters, etcetera.

In step 510, method 500 receives a start indication from the player. In one example of step 510, the player selects, using input device 108, the “Start” button 314 to indicate that the wagering game should begin. In an alternate embodiment, the wagering game begins automatically when the player selects the “Max Bet” button 310.

In step 512, method 500, randomly generates an outcome set 210. In one example of step 512, processor 102 uses a pseudo random number generator to generates outcome set 210 as depicted in FIG. 7.

In step 514, method 500 generates the hit set, the bonus hit set, and optionally generates the miss set. In one example off step 514, processor 102 generates hit set 224 to contain numbers common to both regular selection set 206 and outcome set 210, bonus hit set 226 to contain numbers common to both bonus selection set 208 and outcome set 210, and optionally generates miss set 228 to contain numbers of outcome set 210 that are not in either regular selection set 206 or bonus selection set 208.

In step 515, method 500 determines whether the bonus trigger condition is met. In one example of step 515, processor 102 compares the quantity of numbers in bonus hit set 226 to bonus trigger condition 214 and indicates that the bonus trigger condition is met if the determines number is greater or equal to bonus trigger condition 214. In one example of step 515, processor 102 determines that bonus trigger condition 214 is met when the quantity of numbers in bonus hit set 226 is one or more. In another example of step 515, processor 102 determines that bonus trigger condition 214 is met when the quantity of numbers in bonus hit set 226 is two or more.

Step 516 is a decision. If, in step 516, method 500 determines that the bonus trigger condition 214 is met, method 500 continues with step 518; otherwise, method continues with step 520.

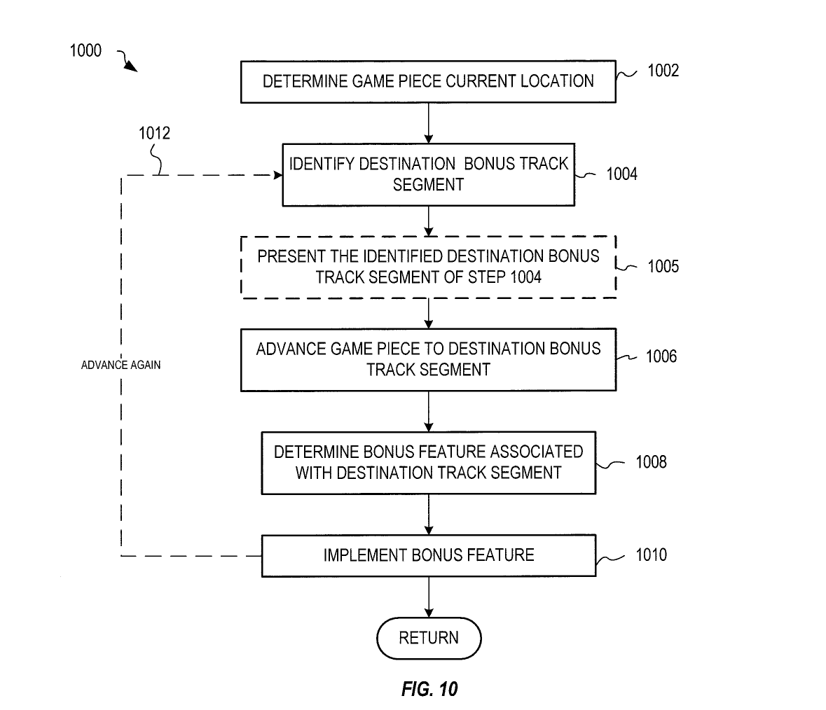

In step 518, method 500 invokes sub-method 900 of FIG. 9 or sub-method 1000 of FIG. 10 to conduct bonus element 230 and continues with step 514 upon return from method 900 to repeat steps 514-518 to process any additional bonus trigger conditions.

In step 520, method 500 determines a pay award based upon the hit set and the bonus hit set using the pay table, and including any bonus feature awards. In one example of step 520, processor 102 determines pay award 232 using pay table 212 and a count of numbers in hit set 224. In another example of step 520, processor 102 determines pay award 232 using pay table 212, a count of numbers in the hit set 224, and a count of numbers in bonus hit set 226. In another example of step 520, processor 102 adds any awards resulting from conducting bonus element 230 to pay award 232.

In step 522, method 500 outputs pay award 232 to the player. In one example of step 522, credits defined within pay award 232 are issued through financial interface 114 in the form of one or more of coins, bills, tickets, or the like. In another example of step 522, credits defined within pay award 232 are added to player credits 134, and a total of credits stored therein is shown on display 106. Stored credits within player credits 134 may be “cashed out” from system 100 in some tangible form upon selection by the player. Method 500 repeats for each play of system 100.

FIG. 9 is a flowchart illustrating one exemplary sub-method 900 for conducting bonus element 230. Sub-method 900 is invoked from step 518 of method 500, FIG. 5.

In step 902, sub-method 900 determines the current location of game piece 312. In one example of step 902, the game piece data 218 is read from memory to determine which track segment 307 is the current location of game piece 312. In step 904, sub-method 900 spins spinner 306 to identify one spinner segment 309 that defines movement of the game piece.

In step 904, sub-method 900 spins the spinner to determine movement of the game piece. In one example of step 904, processor 102 executes instructions of a pseudo random number generator within software 130 to randomly select one of the spinner segments 309 to identify at least one destination location for game piece 312. Each spinner segment 309 may have a different visual representation that is associated with (i.e. the same as) at least two track segments 307. In one example of step 904, the destination location is a destination track segment 307 for game piece 312.

In step 906, sub-method 900 advances the game piece to the first of the identified destination track segments 307. In one example of step 906, processor animates game piece 312 on display 106 to advance in the direction of arrow 320 from its current location to the first identified destination track segment 307. In one embodiment, game piece 312 advances in the direction of arrow 320 to the first encountered destination track segment 307 having the same color 313 (or other visual representation) as the selected one spinner segment 309 of step 904, and game piece data 218 is updated to define the destination track segment 307 as the current location of game piece 312.

In step 908, sub-method 900 determines at least one bonus feature 220 associated with the destination track segment. In one example of step 908, processor 102 determines bonus feature 220 based upon destination track segment 307 upon which game piece 312 lands.

In step 910, sub-method 900 implements the determined bonus feature. In one example of step 910, processor 102 executes instructions of software 130 to implement one or more actions defined by bonus feature 220 and selected from the group including: a free game, a free pick, a spin again, a bonus payout, and a payout multiplier. For example, if bonus feature 220 defines five free picks, processor 102 randomly selects five additional, different and not already included within outcome set 210, numbers from game set 202 and adds them to outcome set 210. In another example of step 910, if the selected bonus award 220 is “spin again”, sub-method 900 repeats steps 904-910, as indicated by dashed line 912.

Method 900 then returns control to method 500.

Repetition of steps 514-518 may result in further invocation of sub-method 900, where each bonus feature 220 implemented within step 910 of sub-method 900 triggers subsequent bonus trigger conditions 214. Continuing with the example of FIG. 4, where bonus feature 220 awards 5 free picks the include the number twelve, this number is added to bonus hit set 226. Then, in step 515, a subsequent bonus trigger condition 214 is met (since the quantity of numbers in bonus hit set 226 is now two and triggers an additional bonus condition), and sub-method 900 repeats.

FIG. 10 is a flowchart illustrating one exemplary sub-method 1000 for conducting bonus element 230. Sub-method 1000 is similar to sub-method 900. One of either sub-method 1000 or sub-method 900 is invoked from step 518 of method 500, FIG. 5, for example. However, in sub-method 1000, identifying means other than a spinner is used to determine the destination bonus track segment as will be discussed below.

In step 1002, method 1000 determines the current location of game piece 312. Step 1002 is similar to step 902. In one example of step 1002, the game piece data 218 is read from memory to determine which track segment 307 is the current location of game piece 312.

In step 1004, sub-method 1000 identifies a destination bonus track segment 307 that defines where the game piece 312 will move. In one example of step 1004, processor 102 executes instructions of a pseudo random number generator within software 130 to randomly generate a number. The destination bonus track segment is then defined by a number of bonus track segments away from the current location of the game piece equivalent to the randomly generated number. For example, if the random number generated is “five” the destination bonus track segment is five bonus track segments away from the current location of the game piece 312 (e.g. segment 311 as illustrated in FIG. 3).

In optional step 1005, the destination bonus track segment 307 is presented to the player. Step 1005 may be implemented by various means of presenting the destination bonus track segment 307 to the player. In one example of step 1005, the randomly generated number used to determine the destination bonus track segment may be displayed to the user by an animation of dice rolling. In another example of step 1005, the randomly generated number used to determine the destination bonus track segment may be displayed to the user by an arrow being shot from a bow toward a target having a plurality of areas each representing a different number. In another example of step 1005, the randomly generated number of step 1004 used to determine the destination bonus track segment is identified to the user by a voice stating the randomly generated number. The randomly generated number identifies how many bonus track segments 220 the game piece 312 will advance to determine the destination bonus track segment. Those skilled in the art will appreciate that other means for presenting (e.g. reels, coins, roulette wheels, etc.) the destination bonus track segment may be used without departing from the scope herein.

In step 1006, sub-method 1000 advances the game piece 312 along bonus track 308, in direction 320, until game piece 312 advances to the destination bonus track segment 307 identified in step 1004. For example, if the randomly generated number is “five”, the game piece 312 advances “five” bonus track segments 220. In one example of step 1006, processor animates game piece 312 on display 106 to advance in the direction of arrow 320 from its current location to the destination bonus track segment. Further, game piece data 218 is updated to define the destination bonus track segment 307 as the current location of game piece 312.

In step 1008, sub-method 1000 determines one bonus feature 220 associated with the destination track segment. In one example of step 1008, processor 102 determines bonus feature 220 based upon destination track segment 307.

In step 1010, sub-method 1000 implements the determined bonus feature. In one example of step 1010, processor 102 executes instructions of software 130 to implement one or more actions defined by bonus feature 220 and selected from the group including: a free game, a free pick, a spin again, a bonus payout, and a payout multiplier. For example, if bonus feature 220 defines five free picks, processor 102 randomly selects five additional, different and not already included within outcome set 210, numbers from game set 202 and adds them to outcome set 210. In another example of step 1010, if the selected bonus feature 220 is “Advance Again”, sub-method 1000 repeats steps 1004-1010, as indicated by dashed line 1012. Method 1000 is not limited in scope to use of the terminology “advance again”, as will be appreciated by those skilled in the art.

Method 1000 then returns control to method 500.

Repetition of steps 514-518 may result in further invocation of sub-method 1000, where each bonus feature 220 implemented within step 1010 of sub-method 1000 triggers subsequent bonus trigger conditions 214. Continuing with the example of FIG. 4, where bonus feature 220 awards 5 free picks to include the number twelve, this number is added to bonus hit set 226. Then, in step 515, a subsequent bonus trigger condition 214 is met (since the quantity of numbers in bonus hit set 226 is now two and triggers an additional bonus condition), and sub-method 1000 repeats.

“Powerball” Bonus Element Trigger:

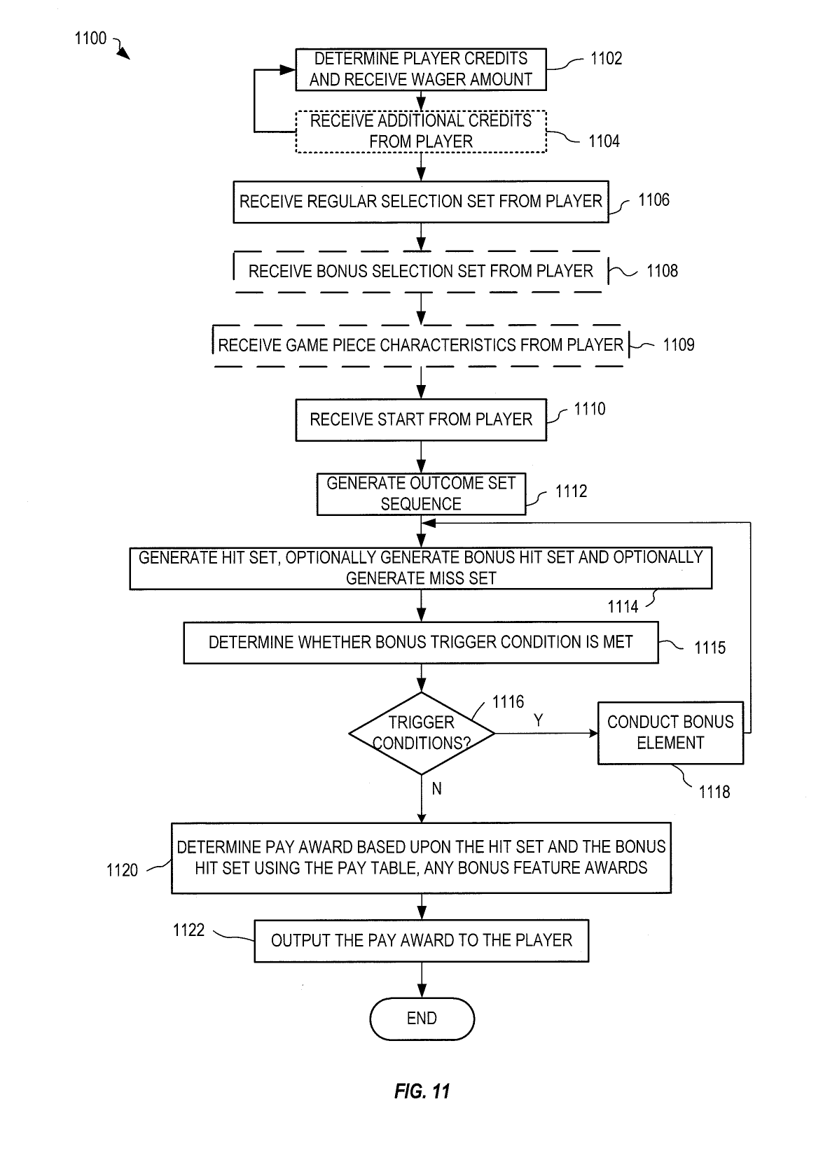

The embodiments above describe bonus trigger conditions where one or more bonus spots match the outcome set. However, the bonus element as discussed above may be implemented using alternate bonus triggers. For example, FIG. 11 depicts one exemplary method 1100 for conducting a wagering game using a powerball type bonus trigger.

Method 1100 is for example implemented as machine readable instructions that are stored as software 130 within memory 104 of system 100 and executed by processor 102 to perform the wagering game.

In step 1102, method 1100 determines the number of credits available to the player in player credits register 134 and receives a wager amount from the player. In one example of step 1102, system 100 receives, via input device 108, an indication from the player as to a number of credits to wager on the current game. In another example of step 1102, the player presses the “Max Bet” button 310, wherein system 100 receives the player's input to play a predetermined maximum wager amount available. Step 1102 is similar to step 502 of FIG. 5.

In one embodiment, no additional wager amount is required to enable the powerball type bonus trigger. In an alternate embodiment, a supplemental, side, or bonus wager amount is required from the player in order to play the wagering game having the powerball type bonus trigger.

Step 1104 is optional. If included, in step 1104, where an insufficient amount of credits, determined in step 1102, is available, method 1100 receives, using financial interface 114 payment from the player (e.g. a bill, coin, ticket, credit card, electronic gaming card or the like) and processor 102 updates player credits register 134 in memory 104 and displays a total number of credits available to the player as determined from the player credit register 134. Then, step 1102 may be repeated.

In step 1106, method 1100 receives a regular selection set from the player. In optional step 1108, method 1100 receives a bonus selection set from the player. Step 1108 is optional because the powerball type bonus trigger condition does not require a bonus selection set, as will be discussed further below in step 1115.

In one example of steps 1106 and 1108, display 106 and input device 108 cooperate to form touch-screen 120 with which the player interacts to select desired spots from keno card 302 by touching their location on display 106. For example, system 100 may receive a regular selection set 206 and bonus selection set 208 consistent with the numbers shown in FIG. 6. In another example of steps 1106 and 1108, the player uses input device 108 and/or financial interface 114 to elect to use a previously stored (e.g., within memory 104 and/or on an inserted card) selection set 204.

In another example of steps 1106 and 1108, the player selects “Quick Pick”, via input device 108, to randomly select numbers for selection set 204 (e.g., a set of numbers randomly generated by processor 102). In yet another example of steps 1106 and 1108, the player indicates, via input device 108, that the selection set 204 of the previous game should be retrieved from memory 104 and used again. As numbers of selection set 204 are selected, they may be indicated on keno card 302 displayed by display 106. In one example, each number of selection set 204 is displayed on display 106 by one or more of: reversing, changing colors, outlining, tagging, or other similar indication methods. Other methods of indicating selection set 204 on keno card 302 may be used without departing from the scope hereof.

Step 1109 is optional. If included, in step 1109, method 1100 receives, via input device 108, the player's selection of characteristics of the bonus game piece 312 for use in the current game. For example, the player selects from a predefined set of game pieces having a variety of colors, shapes, sizes, styles, figures, characters, etcetera.

In step 1110, method 1100 receives a start indication from the player. In one example of step 1110, the player selects, using input device 108, the “Start” button 314 to indicate that the wagering game should begin. In an alternate embodiment, the wagering game begins automatically when the player selects the “Max Bet” button 310.

In step 1112, method 1100 randomly generates an outcome set having an outcome set sequence (i.e. the outcome set is a sequence of numbers (spots) wherein the order generated is significant). In one example of step 1112, processor 102 uses a pseudo random number generator to generate each spot for the outcome set one by one. Accordingly, each spot within outcome set may be identified by the sequence order in which the spot was generated. For example, an outcome set containing twenty outcome set numbers there will be a 1^{st} outcome set number generated, a 2^{nd} outcome set number generated, . . . and a 20^{th} outcome set number generated.

In step 1114, method 1100 generates the hit set, optionally the bonus hit set, and optionally the miss set. In one example off step 1114, processor 102 analyzes the regular selection set 206 against the outcome set generated in step 1112 to generate the hit set. In another example of step 1114, processor 102 additionally generates bonus hit set by comparing the outcome spot generated in step 1112 against the bonus selection set, and optionally generates miss set to contain numbers of outcome set that are not in either regular selection set or bonus selection set.

In step 1115, method 1100 determines whether the bonus trigger condition is met. In one example of step 1115, the bonus trigger condition is defined as a spot (number) value within a particular sequence position of the outcome set matching a spot within one selection set. For example, the bonus trigger condition is met when the fifth outcome set spot generated is a hit in either the regular selection set or the bonus selection set (if optional step 1108 is performed). Accordingly, in step 1115, the bonus trigger condition is determined by the outcome set spot within the designated sequence position, and whether that spot is within the hit set (or optionally within the bonus hit set).

Step 1116 is a decision. If, in step 1116, method 1100 determines that the bonus trigger condition 214 is met, method 1100 continues with step 1118; otherwise, method continues with step 1120.

In step 1118, method 1100 invokes sub-method 900 of FIG. 9 or sub-method 1000 of FIG. 10 to conduct bonus element 230 and upon return from method 900 or 1000 continues with step 1114 to process any additional bonus trigger conditions.

In step 1120, method 1100 determines a pay award based upon the hit set and the bonus hit set using the pay table, and including any bonus feature awards. In one example of step 1120, processor 102 determines pay award 232 using pay table 212 and a count of numbers in hit set 224. In another example of step 1120, processor 102 determines pay award 232 using pay table 212, a count of numbers in the hit set 224, and a count of numbers in bonus hit set 226. In another example of step 1120, processor 102 adds any awards resulting from conducting bonus element 230 to pay award 232.

In step 1122, method 500 outputs pay award 232 to the player. In one example of step 1122, credits defined within pay award 232 are issued through financial interface 114 in the form of one or more of coins, bills, tickets, or the like. In another example of step 1122, credits defined within pay award 232 are added to player credits 134, and a total of credits stored therein is shown on display 106. Stored credits within player credits 134 may be “cashed out” from system 100 in some tangible form upon selection by the player. Method 1100 repeats for each play of system 100.

Method 1100 is not limited in the scope as illustrated in FIG. 11. For example, the bonus trigger condition as determined by step 1115 may be chosen by the player (i.e. the player selects before the game begins which outcome set spot will be the bonus trigger condition (e.g. the 1^{st}, the 4^{th}, or the last outcome set spot generated). Additionally, the bonus trigger condition may require that the 5th outcome spot generated be a hit within the bonus selection set where a hit in the regular selection set does not trigger the bonus element. Other alternatives are included within the scope herein.

Changes may be made in the above methods and systems without departing from the scope hereof It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for conducting, within a wagering game system and with a player, a wagering game having a game set of numbers, the method comprising the steps of:
(i) receiving, within the wagering game system, a selection set comprising: (a) a regular selection set of different numbers selected from the game set and (b) a bonus selection set of at least one different number selected from the game set and different from the numbers of the regular selection set;
(ii) generating, using a processor of the wagering game system, an outcome set comprising a predefined quantity of randomly selected different numbers from the game set;
(iii) generating a hit set of numbers that are common to both the regular selection set and the outcome set;
(iv) generating a bonus hit set of numbers that are common to both the bonus selection set and the outcome set;
(v) determining whether a bonus trigger condition is met based upon the bonus hit set; and
(vi) moving, if the bonus trigger condition is met, a game piece from a current location to a destination location on a bonus track, wherein the destination identifies a bonus feature; and
(vii) implementing, if the bonus trigger condition is met, the bonus feature within the wagering game.

2. The method of claim 1, further comprising the step of determining a pay award based upon a pay table and at least one of (i) a count of numbers in the hit set, (ii) a count of numbers in the bonus hit set, and (iii) the identified bonus feature if the bonus trigger condition is met.

3. The method of claim 2, wherein the pay table defines the pay award based upon (i) an amount of a wager received by the player, and (ii) the quantity of numbers in the regular selection set.

4. The method of claim 3, wherein the pay table defines the pay award based upon the quantity of numbers in the bonus selection set.

5. The method of claim 1, further comprising repeating steps (iii) through (vii) when an additional bonus trigger condition is met.

6. The method of claim 1, wherein the step of generating an outcome set comprises using a pseudo random number generator implemented as machine readable instructions stored in a memory of the wagering game system and executed by the processor.

7. The method of claim 1, wherein the bonus trigger condition is met when the bonus hit set contains one number.

8. The method of claim 1, wherein the bonus trigger condition is met when the bonus hit set contains more than one number.

9. The method of claim 1, wherein the bonus feature is selected from the group comprising: a free game, spin again, one or more free picks, a bonus payout, and a payout multiplier.

10. The method of claim 1, wherein the step of moving the game piece comprises:
randomly selecting at least two destination segments of the bonus track; and
advancing, in a defined direction around the bonus track, the game piece from the current location track segment to a first encountered of the at least two destination segments.

11. The method of claim 10, wherein the step of randomly selecting comprises:
displaying an animation of a spinner on a display of the wagering game system, wherein the animation stops to indicate one of a plurality of spinner segments;
wherein each of the plurality of spinner segments has a different visual representation;
wherein each spinner segment is associated with at least two track segments of the bonus track that have the same visual representation as the spinner segment; and
wherein the one of a plurality of spinner segments is associated with the at least two destination segments.

12. The method of claim 11, wherein the visual representation is selected from the group including: color, fill patterns, shading, alpha-numerical identifiers, and logo identifiers.

13. The method of claim 1, further comprising the step of receiving, from the player, a selection of characteristics of the game piece, the characteristics defining one or both of color and shape.

14. The method of claim 1, wherein the step of moving the game piece comprises:
identifying a destination bonus track segment defined by a number of spaces from the current location of the game piece;
advancing, in a defined direction around the bonus track, the game piece from the current location track segment to the destination bonus track segment;
wherein the number of spaces is determined by a random number generated by a random number generator.

15. The method of claim 14, wherein the step of moving the game piece further comprises presenting the step of identifying a destination bonus track segment to the player using means for presenting.

16. The method of claim 15 wherein the means for presenting comprises animating at least one dice on the display that rolls and lands upon the random number.

17. A system for displaying a computer-implemented wagering game with a game set comprised of a set of numbers, comprising:
a processor;
a display for displaying the game set and a bonus track formed around the game set;
an input device for interacting with the player; and,
a memory storing software comprising machine readable instructions that when executed by the processor perform the steps of:
(i) receiving, using the input device, a selection set comprising: (a) a regular selection set of different numbers selected from the game set and (b) a bonus selection set of at least one different number selected from the game set and different from the numbers of the regular selection set;
(ii) generating an outcome set comprising a predefined quantity of randomly selected different numbers from the game set;
(iii) generating a hit set of numbers that are common to both the regular selection set and the outcome set;
(iv) generating a bonus hit set of numbers that are common to both the bonus selection set and the outcome set;
(v) determining whether a bonus trigger condition is met based upon the bonus hit set; and
(vi) moving, if the bonus trigger condition is met, a game piece from a current location to a destination location on the bonus track, wherein the destination identifies a bonus feature; and
(vii) implementing, if the bonus trigger condition is met, the bonus feature within the wagering game.

18. The system of claim 17, wherein the step of moving comprises:
identifying a destination bonus track segment defined by a number of spaces from the current location of the game piece;
advancing, in a defined direction around the bonus track, the game piece from the current location track segment to the destination bonus track segment;
wherein the number of spaces is determined by a random number generated by a random number generator.

19. The system of claim 18, wherein the step of moving further comprises presenting the step of identifying a destination bonus track segment using a random number generator to the player using means for presenting.

20. The system of claim 19, wherein the means for presenting comprises animating at least one dice on the display that rolls and lands upon the random number.

21. A method for conducting, within a wagering game system and with a player, a wagering game having a game set of numbers, the method comprising the steps of:
(i) receiving, within the wagering game system, a selection set comprising a plurality of different numbers selected from the game set;
(ii) generating, using a processor of the wagering game system, an outcome set having an outcome set sequence, of at least two randomly selected and different numbers of the game set;
(iii) generating a hit set of numbers that are common to both the outcome set and the selection set;
(iv) determining whether a bonus trigger condition is met based upon one number of the outcome set, at a particular position in the order of generation of the outcome set, that is present within the hit set; and
(v) moving, if the bonus trigger condition is met, a game piece from a current location to a destination track segment on a bonus track, wherein the destination track segment identifies a bonus feature; and
(vi) implementing, if the bonus trigger condition is met, the bonus feature within the wagering game.

22. The method of claim 21, wherein the selection set comprises (a) a regular selection set of different numbers selected from the game set and (b) a bonus selection set of at least one different number selected from the game set and different from the numbers of the regular selection set; and wherein the hit set comprises (c) a regular hit set of numbers that are common to both the outcome set and the regular selection set, and (d) a bonus hit set of numbers that are common to both the outcome set and the bonus selection set.

23. The method of claim 22, wherein the step of determining whether a bonus trigger condition is met comprises determining whether the bonus trigger is met based upon whether a number of the outcome set, at a particular position of the outcome set sequence, is present within the bonus hit set.

24. The method of claim 21, wherein the step of moving the game piece comprises:
randomly selecting at least two destination segments of the bonus track; and
advancing, in a defined direction around the bonus track, the game piece from the current location track segment to a first encountered of the at least two destination segments.

25. The method of claim 24, wherein the step of randomly selecting comprises:
displaying, on a display of the wagering game system, an animation of a spinner that stops to indicate one of a plurality of spinner segments, each of the plurality of spinner segments having a different visual representation that is associated with at least two track segments, each of the at least two track segments having the same visual representation as the spinner segment;
wherein the indicated one spinner segment identifies the at least two destination segments.

26. The method of claim 21, wherein the step of moving comprises:
generating, using a random number generator, a random number to determine the destination bonus track segment based the current location of the game piece.
